(19) United States
(12) Patent Application Publication
(10) Pub. No.: US 2011/0224401 A1
(43) Pub. Date: Sep. 15, 2011

(54) APPARATUS FOR SEPARATION BY DISTILLATION

(76) Inventors: Stefan Käshammer, Schifferstadt (DE); Rolf Pinkos, Bad Durkheim (DE); Tobias Wabnitz, Mannheim (DE); Rolf-Hartmuth Fischer, Heidelberg (DE)

(21) Appl. No.: 13/131,790

(22) PCT Filed: Nov. 29, 2009
(86) PCT No.: PCT/EP09/65895

§ 371 Date: May 27, 2011

(30) Foreign Application Priority Data
Nov. 27, 2008 (EP) 08170118.7

(51) Int. Cl. B01D 3/14; C08G 65/20; C08G 63/00

(52) U.S. Cl. 528/361; 202/185.1; 203/87; 528/403

(57) ABSTRACT

The invention relates to an apparatus for separating a liquid substance mixture by distillation, a method for producing a tetrahydrofuran homopolymer and copolymer in which the oligomers in a liquid starting mixture containing oligomers are separated by distillation in such an apparatus, tetrahydrofuran homopolymers and copolymers which can be obtained using said method and have a narrow distribution of the relative molar mass, and the use thereof.

The present invention relates to an apparatus for the fractional distillation of a liquid mixture, a process for preparing polymers (homopolymers or copolymers) of tetrahydrofuran, wherein a liquid oligomer-comprising starting mixture is subjected to removal of the oligomers by distillation in such an apparatus, polymers of tetrahydrofuran having a narrow molecular weight distribution which can be obtained in this way and their use.

In the industrial production of chemical products, liquid mixtures which have to be worked up further by subjecting them to fractionation using distillative methods are frequently obtained. In general, high vaporization rates and mild vaporization as a result of short residence times should be achieved. One specific problem is the provision of polymers having a narrow molecular weight distribution. Depending on the type of polymers and the way in which they are prepared, either synthetic methods or separation processes can be used to solve this problem. Thus, in the preparation of particular polyethers, e.g. polyoxymethylene glycols or polytetrahydrofurans, product mixtures which have to be subjected to removal of low molecular weight oligomers in order to achieve a narrower molecular weight distribution are obtained. For these and further separation problems, there is a need for apparatuses and processes which make effective fractional distillation with very little outlay possible.

Polytetrahydrofuran (polyoxybutylene glycol, polytetramethylene glycol, polyTHF, PTHF) is used as a versatile intermediate in the plastics and synthetic fibers industry. It is used, inter alia, for preparing polyurethane, polyester and polyamide elastomers. In addition, PTHF and some of its derivatives are valuable auxiliaries in many fields of application, for example as dispersants or in the deinking of wastepaper.

PTHF is usually prepared industrially by ring-opening polymerization of tetrahydrofuran (THF) over suitable catalysts. The chain length and thus the average molecular weight of the polymer chains can be controlled by addition of chain termination reagents (telogens). Choice of suitable telogens enables additional functional groups to be introduced at one or both ends of the polymer chain. Other telogens act not only as chain termination reagents but also as comonomer which is additionally built into the growing polymer chain of the PTHF. In industry, two-stage processes in which tetrahydrofuran is polymerized, e.g. in the presence of fluorosulfonic acid or oleum, to form polytetrahydrofuran esters which are subsequently hydrolyzed to polytetrahydrofuran are predominantly carried out. Carrying out the preparation of THF homopolymers and copolymers in the presence of carboxylic anhydrides or mixtures thereof with carboxylic acids, for example in the presence of acetic anhydride or acetic anhydride/acetic acid mixtures, and in the presence of acid catalysts is also known. The THF homopolymers or copolymers can subsequently be liberated from the monoesters and/or diesters obtained in this way by base-catalyzed transesterification with lower alcohols, e.g. methanol. The alcoholic crude product obtained by transesterification comprises THF homopolymers or copolymers together with low molecular weight oligomers having an average molecular weight of from about 100 to 500. These low molecular weight oligomers have, for example, an adverse effect on the polydispersity and/or the color number of the THF homopolymers or copolymers and therefore have to be at least partly separated off. Various processes for reducing the polydispersity of THF homopolymers or copolymers are described in the prior art.

It is known from U.S. Pat. No. 3,925,484 that polytetrahydrofuran having a narrow molecular weight distribution can be prepared by partial depolymerization of polytetrahydrofuran. The low molecular weight oligomers which are split off are converted into THF which is separated off. A disadvantage is that considerable amounts of the higher-value polytetrahydrofuran are converted into THF.

U.S. Pat. No. 4,933,503 describes a process for narrowing the molecular weight distribution of poly(THF), in which the oligomers having a low molecular weight are firstly distilled off at a temperature of from 200° C. to 260° C. and a pressure of less than 0.3 mbar. The distillation residue is then admixed with a mixture of three solvents. This results in formation of three liquid phases which can be separated from one another and from which polytetrahydrofurans having a molecular weight distribution narrower than that of the starting polymer can be isolated.

U.S. Pat. No. 5,282,929 describes a process for narrowing the molecular weight distribution of polytetrahydrofuran, in which this is subjected to an oligomer removal using a wiped film evaporator. A disadvantage is the high capital costs for these special thin film evaporators which are also susceptible to malfunctions because of their rotating apparatus parts.

U.S. Pat. No. 6,355,846 B1 describes a process for narrowing the molecular weight distribution of polytetrahydrofuran or a PTHF copolymer, in which the polymer and a solvent which is inert under the reaction conditions are fed to a stripper. 1,4-Butanediol is preferably used as inert solvent. A disadvantage of this process is the additional use of a solvent which has to be separated off and recirculated.

It is therefore an object of the present invention to provide an apparatus and a process by means of which effective fractional distillation of a mixture with very little outlay is made possible. Specifically, it should thus be made possible to provide polymers of tetrahydrofuran (THF homopolymers or copolymers) which have a narrow molecular weight distribution. The THF homopolymers or copolymers obtained using the apparatus of the invention or by the process of the invention should also generally be colorless and have only little intrinsic color. In addition, the apparatus and the process should allow low molecular weight oligomers to be obtained from feed streams of THF homopolymers or copolymers in a purity which permits their depolymerization to form THF or THF and the corresponding comonomers and subsequent recirculation of the THF obtained by the redissociation to the polymerization.

This object is achieved by an apparatus for the fractional distillation of a liquid mixture, which comprises
a vaporizer having a vaporizer outlet in its lower region,
a vessel having bottom heating, a vessel inlet in its lower region above the bottom and a product offtake in the region of the bottom,
a connection having an internal diameter of at least 75% of the internal diameter of the vaporizer between the vaporizer outlet and the vessel inlet and
a condenser which is located directly above the vessel and is joined in a gastight manner to the latter and has a condensate offtake.

Here, the internal diameter of the vessel is at least as great as the internal diameter of the connection between the vaporizer outlet and the vessel inlet.

For the purposes of the present invention, a liquid mixture is quite generally a composition which is flowable under the pressure and temperature conditions of the process. This comprises liquid components and optionally at least one additional component selected from among solid components and gaseous components in solubilized form.

The liquid mixture to be fractionated comprises at least one more volatile component and at least one less volatile component. Here, the terms “more volatile” and “less volatile” do not have an absolute meaning but rather a relative meaning. “More volatile” means more volatile relative to the “less volatile” component or components, and vice versa. The apparatus of the invention is especially suitable for the fractionation of complex product mixtures as are obtained, for example, by polymerization according to the molecular weight. In the case of mixtures of this type which comprise many components having different boiling points, it is possible to achieve effective fractionation to give a gas phase and a liquid phase which each have a significantly narrower molecular weight distribution than the starting mixture. The average molecular weight and the width of the molecular weight distribution of gas phase and liquid phase can be controlled by appropriate choice of the conditions (e.g. temperature, pressure). In general, sufficient separation power is achieved by a single fractional distillation in the apparatus of the invention. However, to achieve further fractionation, the gas phase and/or liquid phase obtained in the fractional distillation can be subjected to a further fractional distillation in the distillation apparatus of the invention or a different distillation apparatus or another separation process (e.g. GPC, ultrafiltration).

A suitable measure of the width of a molecular weight distribution is the polydispersity, i.e. the ratio of weight average molecular weight (M_{w}) to number average molecular weight (Mₙ). It is likewise possible to report the nonuniformity U=(M_{w}/Mₙ)−1. A suitable measure for the intrinsic color of liquid compositions is the Hazen or APHA color number (determined in accordance with DIN 6271).

For the purposes of the invention, preference is given to using essentially rotationally symmetric components having an aspect ratio of at least 1. They generally have constrictions at their respective top and bottom ends, e.g. curved plates, for example dished ends or three-center vaulted ends (Klöpper or Korbbogen heads), inlets and/or outlets, etc. Preference is given to components having a base body in the form of a cylinder, a truncated cone, a truncated pyramid or a combination of these shapes. In particular, components having a cylindrical base body, hereinafter also referred to as cylindrical components, are used. In this context, the internal diameter is the average diameter in the interior of a component, with optional internals which reduce the diameter, notches, embossings, indentations, etc., resulting from the engineering design or method of manufacture and spigots and also constrictions at its respective top and bottom ends being disregarded.

Suitable vaporizers are in principle any apparatuses having heatable heat transfer surfaces which are customary for this purpose. Preference is given to using a thin film evaporator, for example a falling film evaporator. The vaporizer apparatus used according to the invention is arranged essentially upright. A vaporizer inlet is preferably located in the upper region of the vaporizer. The vaporizer inlet is preferably located in the upper third, in particular in the upper quarter, of the vaporizer. The vaporizer inlet is particularly preferably located at the top end of the vaporizer. The vaporizer outlet is located in the lower region of the vaporizer. The vaporizer outlet is preferably located in the lower third, in particular the lower quarter, of the vaporizer. The vaporizer outlet is particularly preferably located at the bottom end of the vaporizer. A liquid which is to be at least partly vaporized can be fed into the vaporizer in the upper region (especially at the top end) and on flowing down along the side walls forms a film which is heated by means of a suitable heating facility and is at least partly vaporized. In general, a gas-laden liquid stream is discharged in the lower region (especially at the bottom end) of the vaporizer used according to the invention.

The vaporizer is, in particular, a falling film evaporator, preferably a vertical tube evaporator having a shell-and-tube design.

Facilities for heating the vaporizer are known to those skilled in the art from the prior art and are selected and designed according to the respective requirements. If the vaporizer is configured as a vertical tube vaporizer of the shell-and-tube type, the heating medium can be passed around the tubes or through the tubes. Accordingly, the mixture to be fractionated is vaporized in the tubes or at the outsides of the tubes. The heating medium can be any heating medium suitable for the particular case, for example hot water, steam or heat transfer oils. Preference is given to the mixture to be fractionated being vaporized in the tubes, with the heating medium being conveyed through the shell around the tubes. In a useful embodiment, the heating medium and the mixture to be fractionated are conveyed in cocurrent from the top downward.

The discharge from the vaporizer is generally a gas-laden liquid stream. This is introduced via the connection into a downstream vessel. The connection preferably has a tube bend having an angle of curvature of at least 90°, e.g. in the range from 90° to 180°, especially in the range from 90° to 135°.

The vessel has a liquid phase, hereinafter also referred to as bottoms, at the bottom end. Since the level of liquid in the bottom region can vary, bottom region of the vessel is, for the purposes of the present patent application, not only the region in the vessel in which liquid is located but also the entire region below the vessel inlet.

The vessel inlet is positioned in the lower region of the vessel above the maximum height of liquid reached in the bottom. The vessel inlet is preferably located in the lower half of the vessel.

In general, the vessel inlet is designed so that radial inflow of the stream leaving the vaporizer into the vessel occurs.

The vessel has a product offtake in the region of the bottom, especially at the bottom end. A discharge stream comprising the less volatile components can be taken off via this product offtake.

The vessel is equipped with bottom heating. Facilities for heating the bottom region of the vessel are known to those skilled in the art from the prior art and are chosen and designed according to the respective requirements. The bottom region of the vessel is preferably heated from the outside, for example electrically or by means of a heating medium, for example hot water, steam or heat transfer oils. However, it can also be heated in any other way suitable for this application.

In a preferred embodiment of the apparatus of the invention, the connection between the vaporizer outlet and the vessel inlet has an internal diameter in the range from 75% to 200%, preferably in the range from 90% to 150% and in particular in the range from 95% to 125%, of the internal diameter of the vaporizer.

In a useful embodiment, the vaporizer, the connection between the vaporizer outlet and the vessel inlet and the vessel form one structural unit. The connection between vaporizer and vessel is preferably configured so that no constrictions of the cross section are formed. It is therefore preferred that the connection between the vaporizer outlet and the vessel inlet is not a pipe which would cause such a constriction. In particular, the total connection between the vaporizer outlet and the vessel inlet has a uniform diameter. Preference is also given to the vaporizer and/or the vessel being configured so that the respective component essentially has no restrictions of the cross section. For the purposes of the invention, this means that the respective component preferably has a difference between maximum cross section and minimum cross section in the flow direction of not more than 30%, particularly preferably not more than 20%, in particular not more than 10%. Constrictions at the respective top and bottom ends are disregarded. The abovementioned configuration of the unit formed by vaporizer, connection and vessel therefore avoids negative effects caused by restrictions in the cross section, for example condensation of gaseous components in “cold corners”, deposits in dead spaces, undesirable secondary reactions in dead spaces. In particular, the vessel diameter is designed so that expansion effects on going from the vaporizer or the connection into the vessel are avoided.

For the purposes of the present invention, “gastight” means that the components comprised in the starting mixture cannot escape from the plant in an uncontrolled fashion and amounts of atmospheric oxygen and/or atmospheric moisture which have an adverse effect on the process cannot get into the plant during operation under reduced pressure.

In a particularly preferred embodiment of the apparatus of the invention, the ratio of the internal diameter of the vessel to the internal diameter of the connection between the vaporizer outlet and the vessel inlet is in the range from 1:1 to 10:1, preferably in the range from 1:1 to 5:1 and in particular in the range from 1.5:1 to 3:1.

In a further preferred embodiment, the apparatus of the invention comprises a transition between vessel and condenser through which gas can go from the vessel into the condenser. Condensate is retained in the transition, so that essentially no condensate from the condenser gets into the vessel.

In particular, the transition between vessel and condenser is configured in the form of a capture tray for the condensate.

In this embodiment, condensate which flows downward from the condenser is retained in the transition between vessel and condenser and is optionally taken off. The transition is, for example, a horizontal internal which comprises a tray on which the condensate collects. To allow the ascending vapor to get through, the tray is provided with one or more openings. All openings are provided with a construction which prevents the condensate from flowing or dripping back into the vessel. These constructions can be any devices suitable for this purpose. A person skilled in the art will be sufficiently familiar with such devices. Suitable devices are, for example, devices of this type customary for use in rectification tray columns, preferably raised edges, valve discs or bubble caps, in particular bubble caps.

The transition between vessel and condenser can be configured in the form of a cylinder, a truncated cone, a truncated pyramid or a combination of these forms. Here and in the following, the smallest characteristic cross-sectional dimension is taken to be the smallest dimension in the interior perpendicular to the main flow direction of the gaseous overhead product, i.e., for example, the diameter of a round cross section, the edge length of a square cross section or the shortest edge length of a rectangular cross section. Correspondingly, the largest characteristic cross-sectional dimension is considered, here and in the following, to be the largest dimension in the interior perpendicular to the main flow direction of the gaseous overhead product, i.e., for example, the diameter of a round cross section, the diagonal of a square or rectangular cross section.

The largest characteristic cross-sectional dimension in the lower region of the transition, i.e. nearest the vessel, is not larger than the internal diameter of the vessel, for example in the range from 40% to 100%, preferably in the range from 50% to 95%, especially in the range from 55% to 90%, in each case based on the internal diameter of the vessel. The largest characteristic cross-sectional dimension in the upper region of the transition, i.e. nearest the condenser, is preferably smaller than the smallest characteristic cross-sectional dimension of the condenser, for example in the range from 50% to 99%, preferably in the range from 60% to 95%, especially in the range from 75% to 90%, in each case based on the internal diameter of the condenser.

Suitable condensers are adequately known to those skilled in the art, for example heat exchangers such as plate heat exchangers, helical heat exchangers, shell-and-tube heat exchangers, U-tube heat exchangers. The condenser is selected and designed according to requirements.

In a particularly preferred embodiment, the condenser is arranged perpendicular to the main flow direction of the gaseous overhead product, i.e. the gas which passes through the transition before the condensate is separated off.

In a further preferred embodiment of the apparatus of the invention, the bottom region of the vessel comprises liquid. The distance between the liquid surface in the bottom region of the vessel and the condenser inlet is in the range from one to twenty times, preferably in the range from two to fifteen times and in particular in the range from three to ten times, the diameter of the transition between vessel and condenser.

In this arrangement, a comparatively large head space is provided in the vessel. In this way, entrainment of liquid from the bottom region and discharge of this liquid from the vessel with the gaseous overhead product should be largely avoided.

In a particularly useful embodiment, the apparatus of the invention comprises a vacuum unit located downstream of the condenser. As a result, gases preferably leave the apparatus exclusively via the vacuum unit.

A vacuum can be applied in the apparatus by means of the vacuum unit. The vacuum unit is designed so that it can maintain a pressure in the range between 0 mbar and 500 mbar, especially in the range from 0.01 mbar to 300 mbar, in the vessel during operation. The selection and dimensioning of such vacuum units is adequately known to those skilled in the art, e.g. from the field of vacuum distillation.

The present invention further provides a process for the fractionation of a liquid mixture comprising at least one more volatile component and at least one less volatile component, wherein the mixture is subjected to a fractional distillation in an apparatus as defined above.

In particular, the present invention provides a process for preparing polymers of tetrahydrofuran having a narrow molecular weight distribution, wherein a liquid oligomer-comprising starting mixture is subjected to removal of the oligomers by distillation in an apparatus as defined above.

The liquid mixture is preferably a mixture comprising homopolymers or copolymers of tetrahydrofuran. The more volatile component then comprises polymeric compounds having a low molecular weight and optionally also monomers and/or further more volatile compounds different therefrom. The less volatile component comprises polymeric compounds having a higher molecular weight. In a particular embodiment, the invention therefore provides a process for preparing homopolymers and copolymers of tetrahydrofuran, wherein a liquid oligomer-comprising starting mixture is subjected to removal of the oligomers by distillation in an apparatus according to the invention.

The oligomer-comprising starting mixture can be any mixture comprising homopolymers and copolymers of tetrahydrofuran, as is obtained from known production processes. A mixture obtained by transesterification of monoesters and/or diesters of PTHF or of THF copolymers is preferably used as starting mixture.

In the preparation of THF homopolymers or copolymers by transesterification, a monoester and/or diester of a THF homopolymer or copolymer is prepared in a first step by polymerization of THF in the presence of telogens and optionally comonomers in the presence of a catalyst.

Suitable catalysts are acid catalysts, preferably strong inorganic acids or other strongly acidic heterogeneous catalysts. Suitable strong inorganic acids are, for example, hydrochloric acid, sulfuric acid, fluorosulfonic acid, p-toluenesulfonic acid, etc. As strong inorganic acids, preference is given to using fluorosulfonic acid (U.S. Pat. No. 4,371,713) or oleum, optionally together with cocatalysts (JP 5149299).

Heterogeneous catalysts can be used as shaped bodies, e.g. in the form of spheres, rings, cylinders, polyhedra such as prisms, cubes, cuboids, sheet-like bodies such as thin platelets or other geometric bodies. Unsupported catalysts can be shaped by customary methods, e.g. by extrusion, tableting, etc. The shape of the supported catalysts is determined by the shape of the support. As an alternative thereto, the support can be subjected to a shaping process before or after application of the catalytically active component(s). Various shapes can be obtained in a manner known per se by tableting, ram extrusion or screw extrusion. The catalysts can, for example, be used in the form of pressed cylinders, pellets, lozenges, wagon wheels, rings, stars or extrudates such as solid extrudates, polylobel extrudates, hollow extrudates and honeycomb bodies or other geometric bodies.

Suitable catalysts are, for example, catalysts based on bleaching earths, as are described in DE-A 1 226 560. Activated montmorillonites constitute a specific embodiment. The halloysites described in WO 98/31724 are likewise suitable catalysts.

Furthermore, catalysts based on mixed metal oxides are suitable for the polymerization. These include, for example, the mixed metal oxides of the formula MₓO_{y}, where x is an integer and y is in the range from 1 to 3, described in JP-A 04-306 228. Suitable examples are Al₂O₃—SiO₂, SiO₂—TiO₂, SiO₂—ZrO₂ and TiO₂—ZrO₂.

Further suitable catalysts are catalysts based on acidic ion exchangers as described, for example, in U.S. Pat. No. 4,120,903. These include, in particular, polymers comprising alpha-fluorosulfonic acid (for example Nafion®). These are preferably used in the presence of acetic anhydride. Catalysts comprising a metal and perfluoroalkylsulfonic acid anions are also suitable.

JP 61126134A describes a process in which heteropolytungstic acid having a suitable water content is used as polymerization catalyst.

The polymerization is generally carried out at temperatures of from −10° C. to 70° C., preferably from 10° C. to 60° C. The pressure employed is generally not critical to the result of the polymerization, and the polymerization is therefore generally carried out at atmospheric pressure or under the autogenous pressure of the polymerization system.

To avoid formation of ether peroxides, the polymerization is preferably carried out under an inert gas atmosphere. As inert gases, it is possible to use, for example, nitrogen, carbon dioxide or at least one noble gas, e.g. helium or argon. Preference is given to using nitrogen.

The polymerization process can be carried out batchwise or continuously; for economic reasons, the continuous mode of operation is preferred.

In the preparation of THF homopolymers or copolymers involving the formation of carboxylic esters as intermediate product, the average molecular weight of the polymer to be prepared can be controlled via the amount of telogen used. Suitable telogens are carboxylic anhydrides and/or carboxylic acids for the preparation of monoesters and/or diesters of THF homopolymers or copolymers. Preference is given to using organic carboxylic acids or anhydrides thereof. Aliphatic or aromatic carboxylic acids or anhydrides thereof are suitable. Also suitable are monocarboxylic and/or polycarboxylic acids. These preferably comprise from 2 to 12, particularly preferably from 2 to 8, carbon atoms. Preferred examples of aliphatic carboxylic acids are acetic acid, acrylic acid, lactic acid, propionic acid, valeric acid, caproic acid, caprylic acid and pelargonic acid, of which acetic acid is particularly preferred. Examples of aromatic carboxylic acids are phthalic acid and naphthalenecarboxylic acid. Examples of anhydrides of aliphatic polycarboxylic acids are acrylic anhydride, succinic anhydride and maleic anhydride. Very particular preference is given to acetic anhydride.

The concentration of the carboxylic anhydride used as telogen in the feed fed to the polymerization reactor is in the range from 0.03 to 30 mol %, preferably in the range from 0.05 to 20 mol %, particularly preferably in the range from 0.1 to 10 mol %, based on the THF used. If a carboxylic acid is additionally used, the molar ratio in the feed during the ongoing polymerization is usually from 1:20 to 1:20 000, based on carboxylic anhydride used.

The monoesters and diesters of THF copolymers can be prepared by additional use of cyclic ethers which can undergo a ring-opening polymerization as comonomers. Preference is given to three-, four- and five-membered rings, for example 1,2-alkylene oxides, e.g. ethylene oxide or propylene oxide, oxetane, substituted oxetanes such as 3,3-dimethyloxetane, the THF derivatives 2-methyltetrahydrofuran and 3-methyltetrahydrofuran, with 2-methyltetrahydrofuran or 3-methyltetrahydrofuran being particularly preferred.

The use of C₂-C₁₂-diols as comonomers is likewise possible. These can be, for example, ethylene glycol, propylene glycol, butylene glycol, neopentyl glycol, 1,3-propanediol, 2-butyne-1,4-diol, 1,6-hexanediol or low molecular weight PTHF. Further suitable comonomers are cyclic ethers such as 1,2-alkylene oxides, for example ethylene oxide or propylene oxide, 2-methyltetrahydrofuran or 3-methyltetrahydrofuran.

Monoesters and/or diesters of THF homopolymers or copolymers having an average molecular weight in the range from 250 to 10 000 dalton can be prepared in a targeted manner as a function of the telogen content of the polymerization mixture by means of the process. Monoesters and/or diesters of THF homopolymers or copolymers having an average molecular weight in the range from 500 to 5000 dalton, particularly preferably in the range from 650 to 3000 dalton, are preferably obtained. For the purposes of the present patent application, the term “average molecular weight” or “average molar mass” refers to the number average molecular weight Mₙ of the polymers, determined by wet-chemical determination of the OH number.

The reaction discharge from the polymerization can be subjected to at least one work-up step before it is used for the fractional distillation in an apparatus according to the invention. Such a step can be, for example, partial or complete removal of at least one component comprised in the reaction discharge from the polymerization. Thus, the discharge from a polymerization step can be subjected to a filtration in order to remove heterogeneous polymerization catalysts still comprised therein. Suitable filtration apparatuses are, for example, industrially customary layer filters. Furthermore, the reaction discharge from the polymerization can be subjected to a removal of monomers and/or telogens comprised therein. This can preferably be carried out by distillation. The order of the fractionation steps is generally not critical here.

The ester groups in the polymers obtained in this way have to be transformed in a second step. A customary method used here is a reaction with lower alcohols initiated by means of alkaline catalysts. Transesterification using alkaline catalysts is known from the prior art and is described, for example, in DE-A 101 20 801 and DE-A 197 42 342.

A C₁-C₄-alcohol, especially methanol, is preferably used for preparing the alcoholic crude product. Suitable transesterification catalysts are alkoxides, especially sodium methoxide.

In a specific embodiment, the monoesters and/or diesters of THF homopolymers or copolymers obtained by means of the polymerization are firstly admixed with methanol for the transesterification. The content of monoacetate and/or diacetate in the methanol should be in the range from 20 to 80% by weight. Sodium methoxide is then added in an amount of from 50 ppm to 5% by weight.

Since the methanolic crude product obtained after the transesterification can still comprise sodium ions from the transesterification catalyst, the crude product is preferably firstly passed in the presence of a catalytic amount of water directly through at least one ion exchanger. The method of carrying out this ion exchange treatment is disclosed in DE-A 197 58 296, which is hereby expressly incorporated by reference. Preference is given to using a gel-like, strongly acidic ion exchanger. The methanolic crude product which has been freed of the catalyst is preferably additionally filtered through an industrially customary Simplex filter and then fed to the process of the invention. As an alternative, sodium ions can be removed by precipitation using MgSO₄ or H₃PO₄.

Methanol is removed down to a residual content of less than 2% by weight by industrially customary methods using evaporator units.

In a preferred embodiment of the process of the invention,
i a liquid starting mixture comprising oligomers and polymers of tetrahydrofuran is provided,
ii the starting mixture is preheated before it enters the vaporizer,
iii the mixture from step ii is partly vaporized in the vaporizer,
iv the mixture from step iii is conveyed via the connection into the vessel and
v subjected in the vessel to fractional distillation to give a bottom product and an overhead product,
vi a discharge stream comprising polymeric tetrahydrofuran having a narrow molecular weight distribution is taken off from the bottom region of the vessel,
vii the discharge stream is divided into a recycle stream and a product stream,
viii the recycle stream is passed into the starting mixture provided in step i,
ix the overhead product is condensed and
x the condensate is taken off.

The preheating in step iii is usually carried out using a heat exchanger. The temperature at which the starting mixture leaves the heat exchanger is in the range from 5 K to 100 K below, preferably in the range from 5 K to 50 K below, especially in the range from 5 K to 30 K below, the maximum temperature reached by the mixture in the vaporizer. The ratio of volume flow of the starting mixture based on the temperature before entry into the heat exchanger to the heat transfer area is in the range from 0.02 m³/m²/h to 0.8 m³/m²/h, preferably from 0.04 m³/m²/h to 0.6 m³/m²/h, especially from 0.1 m³/m²/h to 0.4 m³/m²/h.

In step viii, the discharge stream is divided into a recycle stream and a product stream in such a way that the recycle stream and the product stream have essentially the same composition.

The bottom is kept as small as possible. It must not exceed a height below the lowermost point of the vessel inlet. The average residence time of the polymer product can be set via the height of the bottom. To avoid thermal damage to the polymer product, the residence time of the polymer product in the vessel is sought as short as possible. Consequently, the height of the bottom is made as small as possible.

In a particularly preferred embodiment of the process of the invention, the average residence time of the polymer product in the bottom region of the vessel is in the range from 5 minutes to 2 hours, preferably in the range from 5 to 60 minutes and in particular in the range from 15 to 30 minutes.

In an embodiment of the process of the invention, the condensate comprises oligomers having a lower molecular weight than the polymer product.

Under the temperature and pressure conditions set in the vessel, the lower oligomers having an average molecular weight of up to 600 vaporize. The vaporized oligomers leave the vessel as overhead product, are condensed in the condenser and are taken off as condensate between vessel and condenser. The polymers having a higher molecular weight remain liquid and can be taken off as polymer product having an average molecular weight in the range from 500 to 10 000 in the bottom region of the vessel.

In a further embodiment of the process of the invention, the condensate comprises essentially oligomers having from 2 to 7 butylene oxide repeating units. “Comprises essentially oligomers having from 2 to 7 butylene oxide repeating units” means that the condensate further comprises small amounts of oligomers having more than 7 butylene oxide repeating units, for example from 8 to 15, preferably from 8 to 12 and in particular from 8 to 10, butylene oxide repeating units. Oligomers having more than 7 butylene oxide repeating units are, for example, comprised in the condensate in an amount in the range from 0 to 10% by weight, preferably in the range from 0 to 5% by weight and in particular in the range from 0 to 2% by weight, in each case based on the total amount of all oligomers comprised in the condensate.

In a further embodiment of the process of the invention, the pressure in the vessel is in the range from 0.01 mbar to 5 mbar and in particular in the range from 0.1 mbar to 1 mbar.

In a preferred embodiment of the process of the invention, the bottom region of the vessel is heated.

Facilities for heating the bottom of the vessel are known to those skilled in the art from the prior art and are selected and designed according to the respective requirements. The bottom region of the vessel is preferably heated from the outside, for example electrically or by means of a heating medium, for example by means of hot water, steam or heat transfer oils. However, it can also be heated in any other way suitable for this application.

In a further embodiment of the process of the invention, the temperature in the bottom region of the vessel is in the range from 170° C. to 280° C. and in particular in the range from 180° C. to 235° C.

In a further embodiment of the process of the invention, the specific loading Θₛᵥ of the vaporizer is in the range from 0.1 m³/m²/h to 0.4 m³/m²/h.

The present invention also provides polymers (homopolymers and copolymers) of tetrahydrofuran which have a narrow molecular weight distribution and can be obtained by a process according to the invention.

The present invention further provides for the use of polymers according to the invention of tetrahydrofuran in the plastics and synthetic fibers industry for producing polyurethanes, polyesters or polyamides, in particular for producing elastic fibers and thermoplastic polyurethanes.

Compared to the apparatuses and processes for narrowing the molecular weight distribution which are known from the prior art, the apparatus of the invention operates continuously and without malfunction even over long periods of operation. Furthermore, no solvents have to be added and removed again. In addition, no depolymerization of PTHF is necessary.

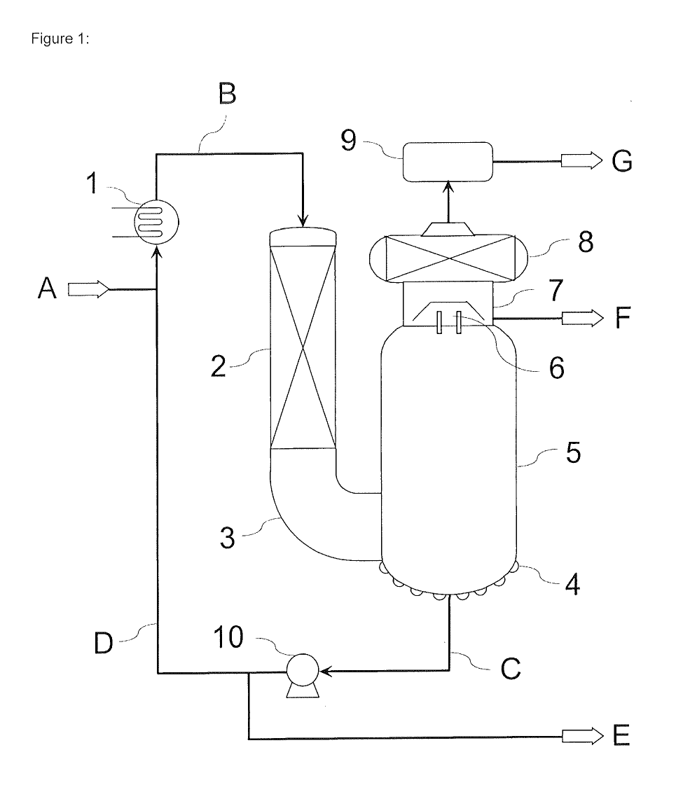

The process is illustrated below with the aid of FIG. 1. FIG. 1 shows a process flow diagram of a preferred embodiment of the process. FIG. 1 serves merely for the purposes of illustration and does not imply any restriction of the invention to this embodiment.

The reference symbols used in FIG. 1 have the following meanings:
A polymer feed
B starting mixture
C discharge stream (polymer product)
D recycle stream
E product stream
F condensate
G offgas
1 heat exchanger
2 vaporizer
3 connection between vaporizer (outlet) and vessel (inlet)
4 bottom heating
5 vessel
6 liquid retention device
7 transition between vessel and condenser
8 condenser
9 vacuum unit
10 circulation pump

The polymer feed A is combined with a recycle stream D to form the starting mixture B. The starting mixture B to be fractionated is heated in the heat exchanger 1 and subsequently partly vaporized in the vaporizer (falling film evaporator) 2. The resulting mixture of gaseous and liquid phase goes from the vaporizer outlet in the lower region of the vaporizer 2 via a curved connection 3 into the vessel inlet in the lower region of the vessel 5.

The lower region of the vessel is heated by means of the bottom heating 4 on the outer wall of the vessel so that the bottom temperature required for the distillation can be set in the vessel 5. The fractionation into an overhead product having a lower average molecular weight and a bottom product having a higher average molecular weight occurs in the vessel 5.

In the bottom region of the vessel 5, bottom product is taken off as discharge stream C via the circulation pump 10. The discharge stream C comprises the polymer product having a narrow molecular weight distribution and is divided downstream of the circulation pump 10 into the recycle stream D and the product stream E. The recycle stream D is subsequently combined with the polymer feed A in order to maintain an appropriate liquid loading of the vaporizer. The required ratio of polymer feed A to recycle stream D determines the amount of product which is obtained from the process as product stream E.

The gaseous overhead product in the upper region of the vessel goes through the transition 7 of the vessel 5 into the condenser 8, passing through the liquid retention device 6 on its way. In the condenser 8, the remaining polymer components are condensed. The liquid retention device 6 prevents the condensate from dripping back into the vessel 5. The condensate F is taken off from the transition between vessel and condenser and can from there be passed to a further purification and/or use.

The gaseous components leave the apparatus via the vacuum unit 9 as offgas G which can be passed to a purification and/or a further use.

### EXAMPLES

Experimental data from a pilot plant having a structure as shown in FIG. 1 are shown in Tables 1 to 3 below. In the tables, the abbreviations have the following meanings:

T_{vaporizer} temperature of the liquid at the outlet of the vaporizer (2)
Θₛᵥ specific liquid loading of the vaporizer
A polymer feed
C discharge stream
F:A ratio of the mass flows of condensate to polymer feed

The APHA color number was determined in accordance with DIN 6271.

The molar mass was determined titrimetrically via the hydroxyl number OHN.

TABLE 1

| Parameter | Unit | MW 1000 | | MW 650 | |
|---|---|---|---|---|---|
| Θ_{SV} | m³/m²/h | 0.26 | | 0.13 | |
| T_{vaporizer} | ° C. | 228 | | 201 | |
| | | A | C | A | C |
| Molar mass | g/mol | 793 | 1010 | 602 | 656 |
| Color number | APHA | 15 | 13 | 15 | 15 |
| Polydispersity D | — | 1.88 | 1.55 | | |

| | | |
|---|---|---|
| F:A | — | 1:0.057 |

TABLE 2

| Parameter | Unit | MW 1800 | | MW 2000 | |
|---|---|---|---|---|---|
| Θ_{SV} | m³/m²/h | 0.25 | | 0.15 | |
| T_{vaporizer} | ° C. | 182 | | 188 | |
| | | A | C | A | C |
| Molar mass | g/mol | 1677 | 1813 | 1785 | 2010 |
| Color number | APHA | 15 | 14 | 12 | 10 |
| Polydispersity D | — | 1.96 | 1.88 | 1.96 | 1.80 |

TABLE 3

| Parameter | Unit | MW 1800 | | MW 2000 | |
|---|---|---|---|---|---|
| Θ_{SV} | m³/m²/h | 0.30 | | 0.25 | |
| T_{vaporizer} | ° C. | 215 | | 225 | |
| | | A | C | A | C |
| Molar mass | g/mol | 1734 | 1820 | 1834 | 2010 |
| Color number | APHA | 19 | 19 | 17 | 16 |
| Polydispersity D | — | 2.11 | 1.92 | | 1.98 |

The examples show that the process of the invention enables a narrowing of the molecular weight distribution to be achieved while maintaining an equally good APHA number.

1.-20. (canceled)

21. An apparatus for the fractional distillation of a liquid mixture, which comprises
a vaporizer comprising a vaporizer outlet in its lower region,
a vessel comprising bottom heating, a vessel inlet in its lower region above the bottom and a product offtake in the region of the bottom,
a connection having an internal diameter of at least 75% of the internal diameter of the vaporizer between the vaporizer outlet and the vessel inlet and
a condenser which is located directly above the vessel and is joined in a gastight manner to the latter and has a condensate offtake,
wherein the internal diameter of the vessel is at least as great as the internal diameter of the connection between the vaporizer outlet and the vessel inlet.

22. The apparatus according to claim 21, wherein the vaporizer is a falling film evaporator.

23. Apparatus according to claim 21, wherein vaporizer is a vertical tube evaporator having a shell-and-tube design.

24. The apparatus according to claim 21, wherein the connection between the vaporizer outlet and the vessel inlet has an internal diameter in the range from 75% to 200% of the internal diameter of the vaporizer.

25. The apparatus according to claim 21, wherein the ratio of the internal diameter of the vessel to the internal diameter of the connection between the vaporizer outlet and the vessel inlet is in the range from 1:1 to 10:1.

26. The apparatus according to claim 21, wherein the connection between the vaporizer outlet and the vessel inlet has an internal diameter in the range from 95% to 125% of the internal diameter of the vaporizer, and the ratio of the internal diameter of the vessel to the internal diameter of the connection between the vaporizer outlet and the vessel inlet is in the range from 1.5:1 to 3:1.

27. The apparatus according to claim 21 having a transition between vessel and condenser, wherein gas can go through the transition from the vessel into the condenser and condensate is retained in the transition, so that essentially no condensate from the condenser gets into the vessel.

28. The apparatus according to claim 27, wherein the transition between vessel and condenser is configured in the form of a capture tray for the condensate.

29. The apparatus according to claim 21, wherein the bottom region of the vessel comprises liquid and the distance between the liquid surface in the bottom region of the vessel and the condenser inlet is in the range from one to twenty times.

30. The apparatus according to claim 21, further comprising a vacuum unit located downstream of the condenser.

31. A process for the fractionation of a liquid mixture comprising at least one more volatile component and at least one less volatile component, said process comprising subjecting the mixture to a fractional distillation in the apparatus according to claim 21.

32. A process for preparing polymers of tetrahydrofuran having a narrow molecular weight distribution, said process comprising subjecting a liquid oligomer-comprising starting mixture to removal of the oligomers by distillation in the apparatus according to claim 21.

33. The process according to claim 32, comprising
i providing a liquid starting mixture comprising oligomers and polymers of tetrahydrofuran,
ii preheating the starting mixture before it enters the vaporizer,
iii partially vaporizing the preheated mixture from step ii in the vaporizer,
iv conveying the partly vaporized mixture from step iii via the connection into the vessel and
v subjecting the partly vaporized mixture in the vessel to fractional distillation to give a bottom product and an overhead product,
vi taking off a discharge stream comprising polymeric tetrahydrofuran having a narrow molecular weight distribution from the bottom region of the vessel,
vii dividing the discharge stream into a recycle stream and a product stream,
viii passing the recycle stream into the starting mixture provided in step i,
ix condensing the overhead product and
x taking off the condensate.

34. The process according to claim 32, wherein the average residence time of the polymer product in the bottom of the vessel is in the range from 5 minutes to 2 hours.

35. The process according to claim 32, wherein the condensate comprises oligomers having a lower molecular weight than the polymer product.

36. The process according to claim 32, wherein the condensate comprises essentially oligomers having from 2 to 7 butylene oxide repeating units.

37. The process according to claim 32, wherein the pressure in the vessel is in the range from 0.01 mbar to 5 mbar.

38. The process according to claim 32, wherein the bottom of the vessel is heated.

39. The process according to claim 32, wherein the temperature in the bottom of the vessel is in the range from 170° C. to 280° C.

40. The process according to claim 32, wherein the average residence time of the polymer product in the bottom of the vessel is in the range from 15 to 30 minutes and the temperature in the bottom of the vessel is in the range from 180° C. to 235° C.

41. The process according to claim 32, wherein the loading of the vaporizer is in the range from 0.1 m³/m²/h to 0.4 m³/m²/h.

42. A polymer of tetrahydrofuran which has a narrow molecular weight distribution and is obtained by the process according to claim 32.

43. A polyurethane, polyester or polyamide which comprises the polymer according to claim 42.

44. A process for producing a polyurethane, polyester, or polyamide which comprises utilizing the polymer according to claim 42.
